(19) United States
(12) Patent Application Publication
(10) Pub. No.: US 2022/0234702 A1
(43) Pub. Date: Jul. 28, 2022

(54) SYSTEMS AND METHODS FOR CONTROLLING A WATERCRAFT

(71) Applicant: Modern Marine LLC, South Bend, IN (US)

(72) Inventors: Kari Ann Maddox, South Bend, IN (US); Todd Fortier, Burgettstown, PA (US)

(21) Appl. No.: 17/582,354

(22) Filed: Jan. 24, 2022

Related U.S. Application Data
(60) Provisional application No. 63/141,012, filed on Jan. 25, 2021.

(51) Int. Cl. B63C 9/00; B63B 34/10; B63H 21/21

(52) U.S. Cl. CPC B63C 9/0005; B63B 34/10; B63B 2203/00; B63H 2021/216; B63H 21/21

(57) ABSTRACT

A system for controlling a watercraft includes a wireless communication device corresponding to a passenger of the watercraft. A controller is in communication with the wireless communication device and the watercraft. The controller is configured to receive range information corresponding to a target distance between the watercraft and the wireless communication device. The controller is further configured to receive displacement data corresponding to an actual distance between the watercraft and the wireless communication device. The controller is further configured to compare the displacement data to the range information. The controller is further configured to determine an overboard condition based on the comparison of the displacement data to the range information. The controller is further configured to communicate an instruction to control the watercraft based on the overboard condition.

### CROSS REFERENCE TO RELATED APPLICATION

Applicant hereby claims the priority benefits under the provisions of 35 U.S.C. § 119, basing said claim of priority on related U.S. Provisional Application No. 63/141,012 filed Jan. 25, 2021, which is incorporated in its entirety herein by reference.

### BACKGROUND OF THE DISCLOSURE

The present disclosure relates to systems and methods for controlling a watercraft and, more particularly to systems and methods for controlling operations of a watercraft based on a user profile associated with a wireless communication device.

### SUMMARY OF THE DISCLOSURE

According to one aspect of the present disclosure, a system for controlling a watercraft is disclosed. The system includes a wireless communication device corresponding to a passenger of the watercraft. A controller is in communication with the wireless communication device and the watercraft. The controller is configured to receive range information corresponding to a target distance between the watercraft and the wireless communication device. The controller is further configured to receive displacement data corresponding to an actual distance between the watercraft and the wireless communication device. The controller is further configured to compare the displacement data to the range information. The controller is further configured to determine an overboard condition based on the comparison of the displacement data to the range information. The controller is further configured to communicate an instruction to control the watercraft based on the overboard condition.

According to another aspect of the present disclosure, a system for controlling a watercraft includes a database storing a user profile associated with a passenger of the watercraft. The system includes a wireless communication device associated with the passenger. The wireless communication device is configured to communicate identification information of the passenger. At least one controller is in communication with the database, the watercraft, and the wireless communication device. The at least one controller is configured to receive the identification information. The at least one controller is further configured to compare the identification information to the user profile. The at least one controller is further configured to determine, based on the comparison of the identification information to the user profile, an authorization condition. The at least one controller is further configured to communicate an instruction to control the watercraft based on the authorization condition.

According to another aspect of the present disclosure, a method for controlling a watercraft includes, at one or more controllers, receiving identification information communicated from a wireless communication device associated with a passenger of the watercraft. The method further includes, at the one or more controllers, accessing a database storing a user profile associated with the passenger of the watercraft. The method further includes, at the one or more controllers, comparing the identification information to the user profile. The method further includes, at the one or more controllers, determining, based on the comparison of the identification information to the user profile, an authorization condition. The method further includes, at the one or more controllers, communicating an instruction to control the watercraft based on the authorization condition.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a perspective view of a passenger on a watercraft wearing a wireless communication device incorporated with the watercraft control system according to one aspect of the present disclosure;

FIG. 2 is a perspective view an overboard condition detected by the watercraft control system of FIG. 1;

FIG. 3 is a top view of a watercraft incorporating a plurality of communication beacons to detect the wireless communication device of the watercraft control system;

FIG. 4 is a block diagram of a watercraft control system according to one aspect of the present disclosure;

FIG. 5 is a flowchart of a method of controlling the watercraft of FIG. 1 according to one aspect of the present disclosure;

FIG. 6 is a front perspective view of a mobile device running a software application of the watercraft control system and displaying a first display of the software application; and

FIG. 7 a front perspective view of a mobile device running a software application of the watercraft control system and displaying a second display of the software application.

The components in the figures are not necessarily to scale, emphasis instead being placed upon illustrating the principles described herein.

### DETAILED DESCRIPTION

The present illustrated embodiments reside primarily in combinations of method steps and apparatus components related to a watercraft control system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

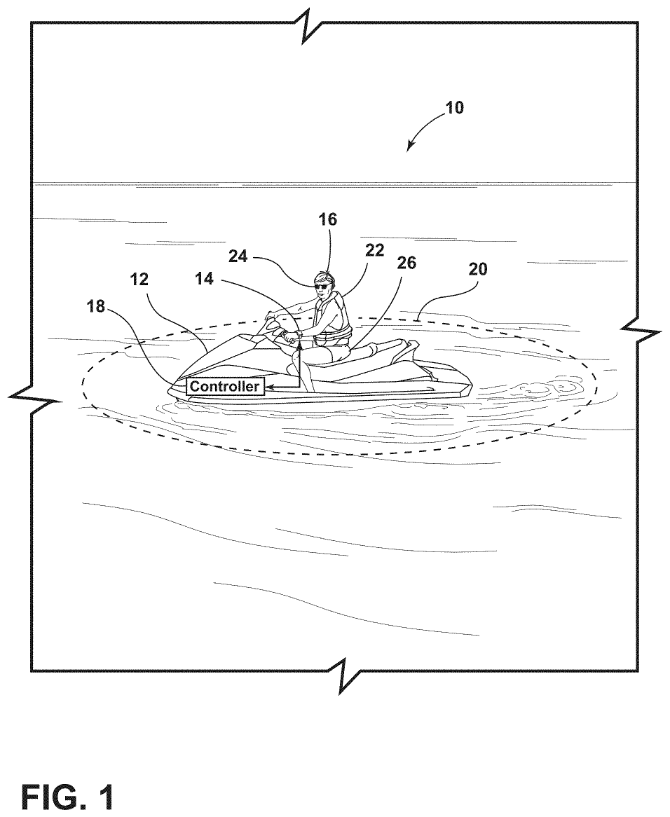

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

Some aspects of the present disclosure relate to a control apparatus, or system 10, that selectively controls a watercraft 12, such as a boat, a yacht, personal watercraft (PWC), or other marine vessel. The device may perform a locating function and an authentication function. Each of these functions may be employed in operation with a wireless communication device 14, which may be incorporated into a wearable device assigned to a user, or may be incorporated into a gadget assigned to the user. The locating function may be employed to detect when the user is no longer onboard the watercraft 12. For example, when the wireless communication device 14 is no longer in communication with one or more processors associated with the watercraft 12, the system 10 may detect one or more conditions associated with the user. For example, if the user, or passenger 16, of the watercraft 12 becomes separated from the watercraft 12, the separation may be detected via severed communication of the wireless communication device 14 with the one or more processors of the watercraft 12. In this scenario, the system 10 may determine that an overboard condition has occurred. Various functions of the watercraft 12 may be employed by the system 10 in reaction to the determination of the condition. For example, the watercraft 12 may be configured to cut the engine when the wireless communication device 14 is no longer detected by the one or more processors of the watercraft 12. In this way, the locating function may be employed to improve the safety of operating the watercraft 12.

According to the authentication function, the system 10 may provide for a plurality of user profiles that have selective access to various operations of the watercraft 12. For example, a wireless communication device 14 assigned to a first passenger of a marine vessel may be associated with a user profile that allows access to starting an engine of the watercraft 12, whereas a mobile wireless communication device 14 associated with a second passenger of the watercraft 12 may have an associated user profile that is blocked from starting the engine of the watercraft 12. The system 10 may provide, for example, a server that stores the first and second user profiles, as well as information related to the corresponding wireless communication devices 14 assigned to the first passenger and the second passenger. In this way, the authentication function may provide for a keyless startup operation of watercraft 12. In some implementations, the wireless communication device 14 is incorporated into a key fob, a lanyard, a wearable device (such as of article of clothing), a backpack, a smart watch, etc. The wireless communication device 14 therefore operates as a security device for authenticating the corresponding user.

The system 10 may also provide for a mobile application that has access to the server and may be employed with a mobile device to communicate with the wireless communication device 14 and/or the one or more processors of the watercraft 12. The mobile application may allow for boat registration and insurance information, safety data related to individual sessions of operating the watercraft 12, operational parameters associated with one or more watercrafts, credential/login information, and other parameters to be recorded as discussed further herein. According to some particular aspects of the present disclosure, the system 10 may allow for a remote starting feature of the watercraft 12, accessible via the software application, based on the user profile.

Referring now to FIGS. 1-7, a system 10 for controlling a watercraft 12 includes a wireless communication device 14 corresponding to a passenger 16 of the watercraft 12. A controller 18 is in communication with the wireless communication device 14 and the watercraft 12. The controller 18 is configured to receive range information corresponding to a target distance 20 between the watercraft 12 and the wireless communication device 14. The controller 18 is further configured to receive displacement data corresponding to an actual distance 22 between the watercraft 12 and the wireless communication device 14. The controller 18 is further configured to compare the displacement data to the range information. The controller 18 is further configured to determine an overboard condition based on the comparison of the displacement data to the range information. The controller 18 is further configured to communicate an instruction to control the watercraft 12 based on the overboard condition.

Referring more particularly to FIG. 1, the wireless communication device 14 may be incorporated with a wearable band for the wrist of the passenger 16. Additionally, or alternatively, the wireless communication device 14 may be incorporated into another wearable device of the passenger 16, such as a life vest 24, a backpack (not shown), sunglasses 26, shorts 28, and the like. In general, the wireless communication device 14 is incorporated into a wearable to allow tracking of the passenger 16. According to some configurations, the wireless communication device 14 may be a lanyard or key fab for attachment to an appendage (e.g., wrist, finger) of the passenger 16. The wireless communication device 14 may be water-resistant and/or water-proof, or may be incorporated with a waterproof article. Although illustrated as a personal watercraft 12, it is generally contemplated that the watercraft 12 may be a multi-passenger boat, such as a yacht, or other mid- to large-size vessel.

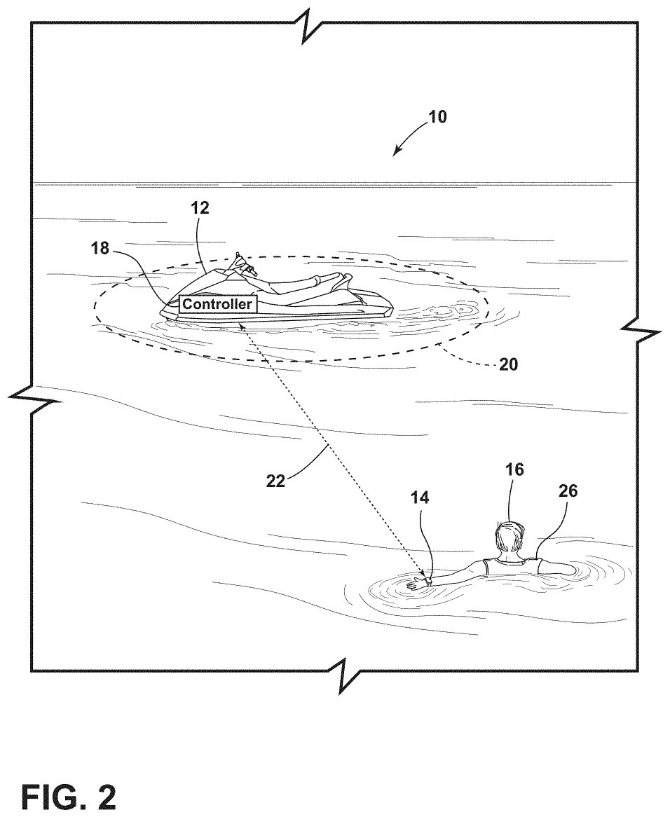

Referring now to FIG. 2, an overboard condition is generally illustrated. In particular, it is generally illustrated that the actual distance 22 exceeds the target distance 20, such that the controller 18 may determine that the overboard condition has occurred. The actual distance 22 may not be precisely determined by the controller 18, however, it may be determined that the actual distance 22 is unknown. For example, if the controller 18 is operable with a received strength signal indicator (RSSI) module that determines a distance the wireless communication is from the RSSI module, then the absence of a signal may indicate that the actual distance 22 has exceeded the target distance 20. Stated differently, after a threshold distance is reached, the wireless communication device 14 may no longer have communication with the RSSI module.

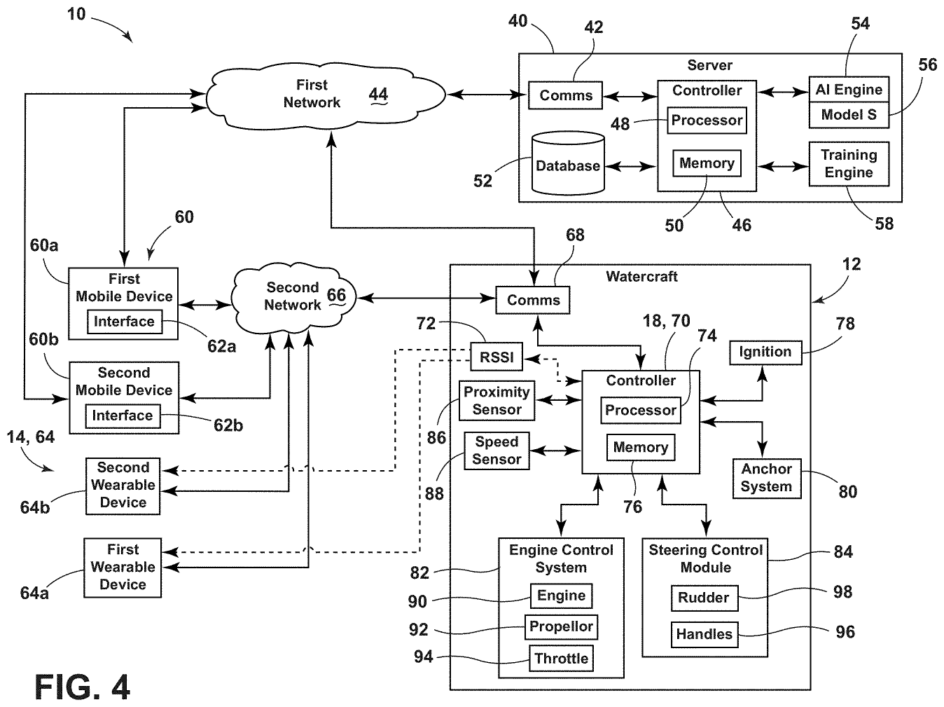

The controller 18 may communicate with the RSSI module to determine that no signal is present and therefore determine the presence of the overboard condition. Although the overboard condition may correspond to the wireless communication device 14 being outside of the target distance 20, it is generally contemplated that, because the wireless communication device 14 may be a wearable communication device according to some embodiments, the overboard condition may also correspond to the passenger 16 being overboard the watercraft 12. Once the overboard condition has been determined, the watercraft 12 may be controlled remotely or based on a preconfigured steering and driving technique. Various modes of operation may be employed when the overboard condition occurs, as further discussed in reference to FIGS. 4-7.

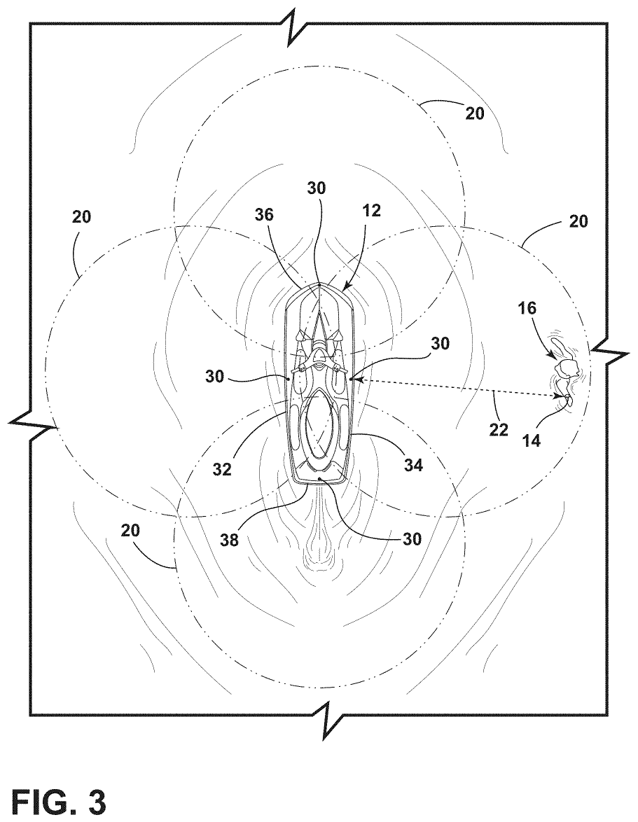

Referring now to FIG. 3, a watercraft 12 incorporating a plurality of communication beacons 30 is provided. In the exemplary embodiment, a communication beacon 30 is placed along each side of the watercraft 12. In particular, a beacon 30 may be placed along each of the port 32, starboard 34, bow 36, and stern sides 38. By providing a plurality of communication beacons 30, such as Bluetooth Low-Energy (BLE) beacons, not only may the wireless communication device 14 be determined to be outside of the target range 20, but a more precise location may be determined when the wireless communication device 14 is inside the target range 20. For example, by utilizing a plurality of beacons 30 implementing RSSI, the controller 18 may be operable to determine the position of the wireless communication device 14 based on triangulation of multiple signals associated with the plurality of beacons 30.

For example, if the wireless communication device 14 is in an area bounded by more than one beacon range (e.g. range 20), a more precise location of the wireless communication may be determined. Alternatively, by providing a beacon 30 along a specific side of the watercraft 12, the relative location (e.g., which side) of the overboard passenger may be determined. In the illustrated example, the passenger 16 is disposed along the starboard side 34 of the watercraft 12, as may be determined by the controller 18 based on the particular beacon 30 that is receiving the signal strength of the wireless communication device 14. In this way, the watercraft 12 may be controlled to stop toward a particular direction (e.g., toward starboard side 34) when the overboard condition is determined, for example, by directing a rudder associated with the watercraft 12 to steer the watercraft 12 towards the starboard side 34 when the engine is deactivated.

Referring now to FIG. 4, the system 10 may include a server 40 configured to store and provide data related to various functions of the watercraft control system 10, such as the authentication function and the location detection function. The server 40 may include one or more computers that may be virtual machines. The server 40 may also include a first communication interface 42 configured to communicate with the wireless communication device 14 and the watercraft 12 via a first network 44. According to some aspects, the first network 44 may include wired and/or wireless network connections, including Wi-Fi, Bluetooth, Bluetooth Low-Energy, ZigBee, near field communications, a cellular data network, global positioning systems, and the like. In general, the server 40 may be operable to process data requests from the mobile communication device and/or the watercraft 12, as illustrated. As a non-limiting example, the server 40 may communicate with the communication device via the first network 44 to access a user profile associated with the communication device and a particular passenger 16.

The server 40 may be configured to communicate an instruction to the watercraft 12, via the first network 44, based on processing an instruction from the wireless communication device 14. For example, the server 40 may receive a request to operate the watercraft 12 from a wireless communication device 14 associated with the passenger 16. The server 40 may be configured to process and record the request and, if validated, communicate an instruction to the controller 18 associated with watercraft 12 to control a function of the watercraft 12. Accordingly, the server 40 may include a first controller 46, which may operate as controller 18, having a first processor 48 and a first memory 50 in communication with a database 52 that stores user profile information (e.g., the user profiles) and other information corresponding to the watercraft 12 and/or the passengers 16. In this way, the server 40 is generally configured to store data related to the operating functions of the system 10.

The first memory 50 may include instructions that, when executed by the first processor 48, are operable to calculate and/or determine various data related to the functions of the system 10. For example, the database 52 may store a plurality of user profiles associated with the plurality of passengers 16. When the first controller 46 receives an instruction to determine whether a particular user profile has operator rights to control the watercraft 12, the first controller 46 may access the database 52 to compare the particular user profile to the plurality of user profiles. In response to the comparison, the first controller 46 may communicate with a controller associated with the watercraft 12.

An artificial intelligence engine 54 may further be provided with the server 40 for interacting with the database 52 and the memory 50 when performing various techniques, such as generating various machine learning models 56. The models 56 may be trained to predict, for example, the overboard condition based on iterative training of particular signal strengths associated with the wireless communication device 14 being located near the watercraft 12. For example, the data may include cohort data of other, or previous events associated with false flags of an overboard condition. Further, the data can include can include previous event data associated with other events that incorrectly flagged an overboard condition, such as an impact of waves striking the watercraft 12, unexpected accelerations in the position of the wireless communication device 14 relative to the watercraft 12, and the like. The models 56 may be trained on this data in order associate certain data points with the overboard condition.

The one or more machine learning models 56 may include a single level of linear or nonlinear operations and/or the machine learning models 56 may be trained via a deep network. For example, the neural network may be a machine learning model 56 having multiple levels of nonlinear operations. Deep networks may include neural networks, including generative adversarial networks, convolutional neural networks, recurrent neural networks with one or more hidden layers, and fully connected neural networks. The models 56 may be trained to determine a refined target distance 20 for the wireless communication device 14 that prevents false flags from occurring. Data gathered prior to and during deployment may be implemented via the artificial intelligence engine 54 to further train the models 56 to detect the overboard condition. The models 56 may also be trained to determine an optimal return distance to the overboard passenger 16 that maximizes proximity to the overboard passenger 16 without contacting the overboard passenger 16.

The server 40 may further include a training engine 58 capable of training the models 56 based on initial data, as well as feedback data from the watercraft 12 and the wireless communication device 14. The training engine 58 may include a rackmount server, a personal computer, a smart phone, an Internet of Things (IOT) device, or any other computing device. The models 56 may be trained to match patterns of data provided via an RSSI module on board the watercraft 12, or other distance detection modules for calculating a distance the wireless communication device 14 is from the watercraft 12. The one or more machine learning models 56 may be trained to receive a first set of parameters as an input in map or otherwise associate or algorithmically associate the first set of parameters with a second set of parameters associated with an adverse event, such as an overboard condition, an authorized operator not onboard condition, etc. The models 56 may be trained via repeated tests that incorporate proximity sensors of the watercraft 12 (e.g., capacitive, inductive, RADAR, and/or LIDAR sensors) to identify contact with an object in the water, as well as RSSI data indicating proximity to the object.

The first network 44 may be in communication with the watercraft 12, as previously described, as well as a plurality of mobile devices 60. For example, the plurality of mobile devices 60 may include a first mobile device 60a and second mobile device 60b. The mobile device 60 may be a communication device such as a smart phone or other interactive computing device, such as a tablet, a laptop, or an onboard controller of the watercraft 12. Each mobile device 60 may include an interface 62a, 62b for interacting with the mobile application of the present disclosure. In this way, the interface 62a, 62b may allow for user input to the mobile devices 60 to enter the user profile information stored in the server 40. The interface 62a, 62b may also allow for operating functions of the watercraft 12, such as for control over the watercraft 12, control of authorized user access, and various features employed to limit access to functions associated with the system 10. Each of the mobile devices 60 may be associated with an individual wireless communication device 14, such as a first wearable device 64a and a second wearable device 64b. In particular, the first wearable device 64a may be synced with the first mobile device 60a, and the second wearable device 64b may be synced with the second mobile device 60b.

Each mobile device 60 and wearable device 64 may be associated with a particular passenger 16 of the watercraft 12, with a first passenger associated with the first mobile device 60a and the first wearable device 64a and a second passenger associated with the second mobile device 60b and the second wearable device 64b. Each of the mobile devices 60 and the wearable devices 64 may be in communication with a second network 66. The second network 66 may be configured similar to or different than the first network 44 in terms of protocol. However, according to some non-limiting examples, the second network 66 may be operable to communicate with a plurality of mobile devices 60 and a plurality of wireless communication devices 14 associated with passengers 16 of the watercraft 12 or potential passengers 16 of watercraft 12. The second network 66 may comprise any number of wireless or wired communication protocols previously described in reference to the first network 44, but in particular examples disclosed herein, the second network 66 may be a Bluetooth network.

In the exemplary Bluetooth network example, the first wearable device 64a may be tethered with the first mobile device 60a and the second wearable device 64b may be tethered with the second mobile device 60b. In addition, the wearable devices 64 may be tethered with a Bluetooth communication device associated with the watercraft 12, such that a distance from the wearable devices 64 to the watercraft 12 may be determined by the controller 18 (e.g., second controller 70) associated with the watercraft 12 and/or associated with the mobile devices 60.

Referring now more particularly to the watercraft 12 of FIG. 3, a second communication interface 68 may be provided in the watercraft 12 to provide access to the first network 44 and the second network 66. Via the communication interface 68, a second controller 70 corresponding to the watercraft 12 may be in communication with the server 40, the mobile devices 60, and the wireless communication devices 14. The second communication interface 68 may be similar to or different than the first communication interface 42 in terms of protocol. For example, the second communication interface 68 may include wired and/or wireless network connections, including Wi-Fi, Bluetooth, ZigBee, near field communications, a cellular network, a global position system, and the like. The second communication interface 68 may further include an RSSI module 72. The RSSI module 72 may alternatively be provided separately from the communication interface 68 as illustrated. The RSSI module 72 may be configured to detect the strength of the signal from the wireless communication device 14. The second controller 70, similar to the first controller 46, may also include a second processor 74 and a second memory 76. The second memory 76 may store instructions that, when executed by the second processor 74, cause the second controller 70 to control various functions of the watercraft 12.

For example, the second controller 70 may be in communication with an ignition system 78 and be operable to control the ignition system 78. The second controller 70 may also be in communication with an anchor system 80 and operable to control the anchor system 80. The second controller 70 may also be in communication with an engine control system 82 and a steering control module 84 associated with the watercraft 12. Based on instructions received from at least one of the first mobile device 60a, the second mobile device 60b, the first and second wearable devices 64a, 64b, and the server 40, the second controller 70 may be operable to control at least one of the ignition system 78, the anchor system 80, the steering control module 84, and the engine control system 82.

The second controller 70 may also be in communication with a proximity sensor 86 and a speed sensor 88 associated with the watercraft 12. Other systems not illustrated, such as a human-machine interface (HMI) configured to operate the watercraft 12, may be in communication with second controller 70. For example, wind sensors, directional sensors, and the like may be monitored by the second controller 70 and be operable to influence control over any one of the systems described. For example, the proximity sensor 86 may be utilized to determine a proximity of an overboard passenger in the water relative to the watercraft 12. In addition, the speed sensor 88 may be monitored by the second controller 70 for influencing control over the engine control system 82.

The engine control system 82 may include an engine 90, a propeller 92, and a throttle 94. The engine control system 82 may also include any other thrusting means for moving the watercraft 12 through a body of water. The Throttle 94 may be employed to control a speed, or rotation per minute (RPM), of the engine 90. Additionally, or alternatively, the throttle 94 may be employed to control a speed or acceleration of the propeller 92 of the engine control system 82. In this way, the speed of the watercraft 12 may be controlled by the second controller 70.

The steering control module 84 may include a rudder 98 for controlling the direction of the watercraft 12. Handles 96, or another steering mechanism, such as a steering wheel, may be provided with the steering control module 84 for controlling the direction of the rudder 98. Additionally, or alternatively, the steering control module 84 may be an electronic steering control module 84 that does not require physical input from the steering wheel/handles 96 to control the direction of the watercraft 12.

The system 10 may provide for a number of operations associated with authentication and/or detection of various events, such as the overboard condition. In a first operation, the watercraft 12 may be operable to deactivate the ignition of the watercraft 12 in response to the detection of the overboard condition. Additionally, or alternatively, the second controller 70 may be configured to activate the anchor system 80 of the watercraft 12 to secure the watercraft 12 to a position in the body of water near the overboard passenger 16. Other responses of the system 10 may include an activation of the steering control module 84 and/or the engine control system 82. For example, according to some configurations, when the RSSI module 72 no longer detects a signal of the wearable device 64, or the signal of the wearable device 64 is so faint that it is below a certain threshold, the second controller 70 may be configured to slow the engine speed and/or cut the engine temporarily. Because the wearable device 64 may not have communication via the RSSI module 72 to the watercraft 12, the wearable device 64 may alternatively communicate with the watercraft 12 via an auxiliary communication module operable via GPS communication, mobile data, or the like.

The positional data of the wearable device 64 may be communicated to the watercraft 12 via the auxiliary communication module. In response, the controller 18 (e.g., second controller 70) onboard the watercraft 12 may autonomously steer and propel the watercraft 12 toward the position of the wearable device 64 according to the GPS coordinates provided. The watercraft 12 may be controlled at a low rate of speed (e.g., 1 km/hour, 2 km/hour, 5 km/hour) until the RSSI module 72 receives signal strength from the wireless communication device 14. The controller 18 (e.g., second controller 70) may be configured to once again deactivate the ignition and/or slow the engine 90 or the propeller 92. In this way, the system 10 may provide for a safe response to detection of the overboard condition, such that the watercraft 12 may near the overboard passenger 16 without contacting the overboard passenger 16 in the water. It is generally contemplated that, in this configuration, the wearable device 64 includes the auxiliary communication module (e.g., having one of a satellite-based navigation protocol and a cellular radio frequency protocol) in addition to a primary communication module having a short-range radio frequency hopping protocol

According to other aspects of the overboard condition operation, the second controller 70 may monitor the proximity sensor to determine when the watercraft 12 is near the overboard passenger 16. If the second controller 70 determines that contact with passenger 16 may occur absent a change in steering and/or control, the second controller 70 may immediately activate the anchor system 80 and control the rudder 98 to move the watercraft 12 away from the overboard passenger 16.

Other aspects of the passenger 16 overboard operation may include active control over the watercraft 12 via the wearable device 64 and/or the mobile device 60. For example, when the overboard condition has occurred, the wearable device 64 (e.g., smartwatch), may include an interface that allows control, at low speeds, over the watercraft 12 to direct the watercraft 12 toward the passenger 16. For example, the watercraft 12 may be controlled via user input to a display screen of a smartwatch and/or a smart phone. The screen may display digital objects indicating left or right directions and forward/reverse directions for control over the steering of the watercraft 12. In addition, the interface of the wearable device 64 and/or the mobile device 60 may allow control over the communication interface 68 of the watercraft 12, such that help signals may be communicated from the communication module 68 of the watercraft 12 to other watercrafts and/or authorities (e.g., police, first responders, DNR, etc.). In this way, the wearable device 64 may provide additional safety features for the passengers 16. The wireless communication device 14 may further be configured to transmit an SOS signal via cellular communication to the authorities, such as Coast Guard, DNR, etc.

According to a second operation, the system 10 may perform an authentication operation to limit access to control of the watercraft 12. The authentication operation may be performed via one or more of the controllers 18 (e.g., the first controller 46, the second controller 70, a controller of the mobile device 60) in communication with the database 52, the watercraft 12, and the wireless communication device 14. The at least one controller 18 may be configured to receive identification information and compare the identification information to a user profile stored in the database 52. The controller 18 (e.g., first controller 46) may further determine, based on the comparison of the identification information to the user profile, an authorization condition. The at least one controller 18 (e.g., first controller 46) may then be configured to communicate an instruction to control the watercraft 12 based on the authorization condition.

For example, a controller of the first mobile device 60a may be configured to communicate with the first controller 46. In particular, the controller of the first mobile device 60a may communicate an instruction to the first controller 46 to compare the user profile associated with the first wearable device 64a to the database 52 of user profiles. The first controller 46 may then communicate an instruction to the second controller 70 to activate the ignition system 78 of the watercraft 12 in response to determining that the particular user profile has operator permissions. In this way, the user profile associated with the operator of the watercraft 12 may be authenticated in the server 40 and determine whether control of the watercraft 12 is allowed. It is generally contemplated that other operations of the watercraft 12 may be controlled based on user profiles not relegated to just the ignition system 78. For example, the engine control system 82 may be limited to preset speeds associated with the user profile as determined by a user profile of the owner of the watercraft 12 (e.g., an administrator profile). In addition, the engine control system 82 may be controlled to operate within a certain geographical boundary set by the user profile of the owner. It is generally contemplated that the word owner/administrator may refer to any authorized user relative to an unauthorized user or to a person with legal right of ownership of the watercraft 12.

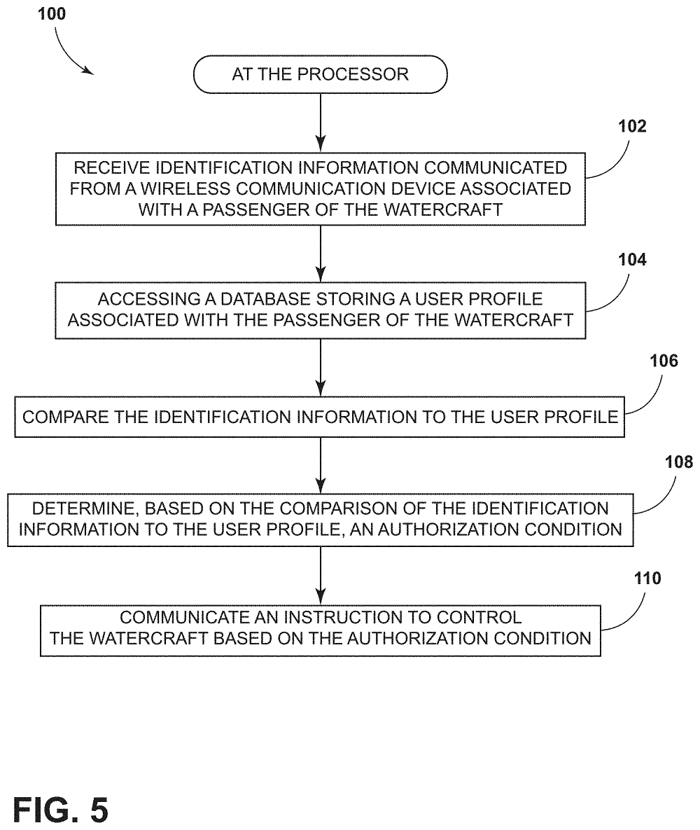

Referring now to FIG. 5, a method 100 for controlling watercraft 12 is provided. At step 102, a processor may be configured to receive identification information communicated from a wireless communication device 14 associated with the passenger 16 of the watercraft 12. At step 104, the processor may access a database 52 storing a user profile associated with the passenger 16 of the watercraft 12. At step 106, the identification information may be compared to the user profile at the processor. At step 108, the processor may determine, based on the comparison of the identification information to the user profile, an authorization condition. At step 110, the processor may communicate an instruction to control the watercraft 12 based on the authorization condition.

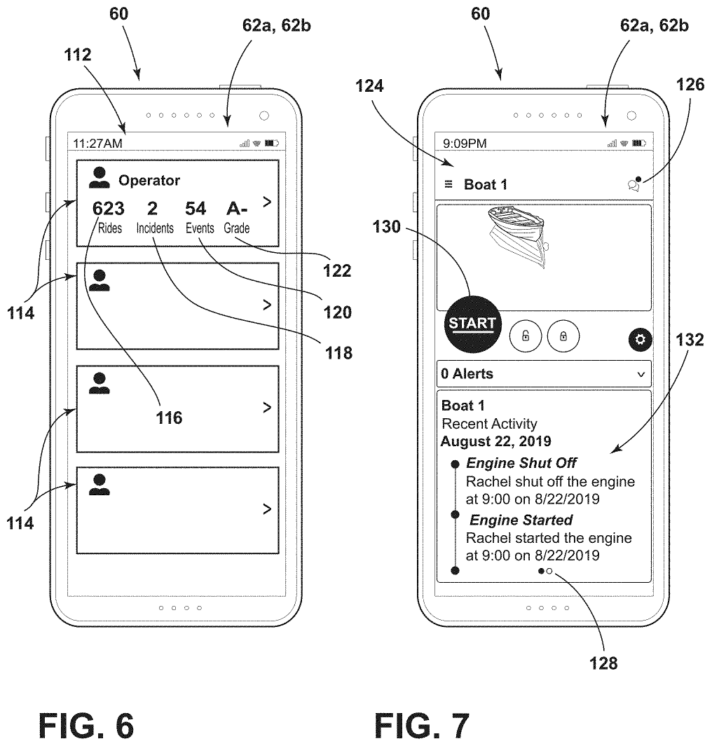

Referring now to FIGS. 6 and 7, the mobile device 60 previously described is illustrated running the software application. With particular reference to FIG. 6, the software application may include a first display 112 indicating operator data 114 associated with potential operators of the watercraft 12. Each potential operator may have a corresponding user profile that has certain limitations, as previously described. The operator data 114 may include ride data 116, incident data 118, event data 120, and grade data 122 corresponding to the performance of the operator associated with a particular user profile. For example, the ride data 116 may indicate a number of trips, or rides, that particular operator has taken with a given watercraft 12 or with watercrafts generally. The incident data 118 may indicate the number of incidents (e.g., running out of fuel, collision with land, collision with another watercraft, an emergency, a regulatory infraction, etc.) that have occurred while the operator has been on a trip with the particular watercraft 12 or any watercraft 12. The event data 120 may indicate the number of events that have occurred during a trip with the operator, including the incidents, as well as other events with less severity, such as operating the boat past a curfew, near misses with other watercrafts 12, and the like. The grade data 122 may correspond to an overall performance of the operator based on the ride data 116, incident data 118, and event data 120. The first display 112 may provide a simple way for an administrator to restrict access to particular features or to operation of the watercraft 12 altogether to specific operators. As such, the first display 112 may be accessible only to the administrator profile.

Referring now to FIG. 7, a second display 124 of the software application is illustrated. A communication button 126 may be provided in the software application on the second display 124. The communication button 126 may launch a communication display that allows a first passenger using the first mobile device 60a to communicate, via text communication, to a second passenger using the second mobile device 60b. The second display 124 may be a dashboard for the software application and be configured to toggle between a number of registered watercrafts 12, as indicated by an indicator 128 at the bottom of the second display 124. For instance, if a user swipes to the left or to the right, the software application may be configured to display a third display screen indicating a second watercraft 12 associated with the authenticated user. The second display screen 124 may include a start button 130 that, when activated by the user, may initialize a starting sequence of the selected watercraft 12. Once the start button 130 has been engaged, the ignition of the marine vessel may be activated depending on the proximity of the mobile device 60 and/or the wearable device 64 relative to the selected watercraft 12.

An activity log 132 may be displayed on the second display 124 for listing events associated with the selected watercraft 12. For example, the activity log 132 may display an event such as the engine of the watercraft 12 starting and/or the engine of the watercraft 12 being deactivated. In addition, the activity log 132 may indicate the particular user profile engaged in the activity listed. For example, as illustrated, user profile “Rachel” started the engine at nine o'clock on Aug. 22, 2019, and deactivated the engine at the same time. By accessing the second display 124, an authenticated user may track the specific activity of the watercraft 12 and the activity of the users in relation to the watercraft 12.

The system 10 may also perform various data tracking operations and alert operations for implementation with insurance provider software, as well as for operating software for marinas. The data tracking operations may employ algorithms on the data stored in the database. According to one tracking operation, the user profile may include a vehicle identification number, boater registration information (e.g., watercraft operator licenses), and insurance data. Passengers 16 with access to this information may enter the information via the mobile application to be associated as an owner/administrator. An administrator of the watercraft 12 may have access to activity of the watercraft 12, as described, but additionally may be alerted for specific events. For example, the second controller 70 on-board the watercraft 12 or the first controller 46 associated with the server 40, may communicate a message to the mobile device 60 of the administrator to indicate when an uninsured passenger is operating the watercraft 12. The message may be in the form of an SMS message, an email, or other message communicated to the mobile device 60 via the first or second networks 44, 66. Additionally, the message may be communicated to a second watercraft owned by the administrator, and a message may be displayed on an on-board HMI of the second watercraft. In this way, the system 10 may provide a check for uninsured motorists.

The uninsured operator event may, additionally or alternatively, be communicated to a computing device running the insurance software and/or the operating software of the marina. In this way, an insurance provider and/or a marina where the watercraft 12 is assigned may receive alerts via the alert operation of the system 10. This may circumvent local authority involvement (e.g., police, department of natural resources, etc.). Other events, such as manufacturer recall notices, may be communicated via the mobile application to the passengers 16.

Another data tracking operation provided by the system 10 may be a safety tracking function. The safety tracking operation may be employed with the second controller 70 to monitor the various watercraft control systems previously described (e.g., the steering system 84, the engine control system 82, GPS history, etc.) over extended periods (days, weeks, trips (e.g., duration from departure of dock until return to dock)). In this way, the system 10 may have access to the “black box” of the watercraft 12. Based on the data received from monitoring the systems of the watercraft 12, the first controller 46 may determine a safety rating assigned to the user profile of the operator. The administrator may, via the mobile application, allow the safety rating to be communicated to a computer device corresponding to the insurance provider. Performance-based insurance incentives may therefore be more readily available by providing insurance carriers access to data stored in the database 52 (e.g., the safety ratings).

Another data tracking operation may include a maintenance tracking operation. For example, a user profile may be associated with the marina and be granted access to data motored from the black box and stored either in on-board memory (e.g., second memory 76) or in the server 40. The first controller 46 may be configured to determine a maintenance score corresponding to the health of the watercraft 12 based on the wear and/or harm done to the watercraft 12 over time. The marina profile may have access to the maintenance score and may allow a computer system of the marina to determine the money value of the watercraft 12 based on the maintenance score. In addition to a maintenance tracking operation, the system 10 may also track temporary health parameters, such as battery charge, water capacity/volume of the bilge, fuel levels, and the like. One or more of the controllers 18, 46, 70 may be operable to alert the passengers 16 via haptic feedback (e.g., vibration) of the wearable device 64 and or visual/audio feedback via a speaker or interface of the wearable device 64 based on the temporary health parameters.

One or more of the controllers 18 may further be configured to determine whether an accident has occurred based on the RSSI and watercraft 12 speed. For example, a sudden loss of Bluetooth signal concurrent with a deactivation of the engine 90 and or proximity or speed sensor 86, 88 feedback indicating contact with an object (e.g., a person) may be determined via the second controller 70 and communicated to the administrator profile via the server 40. Thus, the second controller 70 may be configured to receive watercraft sensor data and compare the watercraft sensor data to the RSSI data to identify a collision. Collision event data may then be stored in the server 40 and/or communicated to a user profile, a computing device associated with the marina, and/or a computing device associated with the insurance provider.

As previously described, the user profiles may be limited according to restrictions set by the administrator. For example, the some user profiles may be authenticated to operate the watercraft 12 during specific times of the day and/or days of the week. Additionally, some user profiles may be authenticated to operate the watercraft 12 when a second user profile is detected aboard the watercraft 12. The number of profiles maintained by the server 40 may be limited based on a subscription fee.

It is generally contemplated that the wireless communication device 14 may be solar-powered and include a lighting feature and/or a haptic device for providing haptic feedback to the passenger 16 when the system 10 initiates a finding function. For example, the software application may include a digital object that, when activated by the passenger 16, utilizes a communication system of the mobile device 60 to communicate with the wearable device 64 to determine the location of the wearable device 64. In response to the communication, the wearable device 64 may illuminate and/or vibrate. The wireless communication device 14 may further be configured to illuminate/vibrate in when hazardous events related to the watercraft 12 are detected via the second controller 70. For example, the second controller 70 may be in communication with a depth sensor operable to detect shallow water. The second controller 70 may communicate an instruction to the mobile device 60 and/or the wireless communication device 14 to alert the passenger of a potential collision event with the floor of the body of water. Other hazardous events, such as low fuel, low oil, or battery low alerts may be communicated to the wireless communication device 14. The wireless communication device 14 may also be equipped with a speaker system. The speaker system may be operable to communicate an alarm when the overboard condition is determined.

According to one aspect of the present disclosure, a system for controlling a watercraft is disclosed. The system includes a wireless communication device corresponding to a passenger of the watercraft. A controller is in communication with the wireless communication device and the watercraft. The controller is configured to receive range information corresponding to a target distance between the watercraft and the wireless communication device. The controller is further configured to receive displacement data corresponding to an actual distance between the watercraft and the wireless communication device. The controller is further configured to compare the displacement data to the range information. The controller is further configured to determine an overboard condition based on the comparison of the displacement data to the range information. The controller is further configured to communicate an instruction to control the watercraft based on the overboard condition.

According to one aspect of the disclosure, the controller is in communication with an engine control system of the watercraft. The instruction may be communicated to the engine control system to deactivate an engine of the watercraft.

According to one aspect of the disclosure, the overboard condition corresponds to the passenger being spaced from the watercraft.

According to one aspect of the disclosure, the overboard condition corresponds to the wireless communication device being spaced from the watercraft.

According to one aspect of the disclosure, the wireless communication device is a wearable device attached to an appendage of the passenger.

According to one aspect of the disclosure, an interface is disposed on the wireless communication device and configured to receive a user input. The wireless communication device may be operable to control the engine control system based on the user input.

According to one aspect of the disclosure, the watercraft includes a steering control system operably controlled via the user input.

According to one aspect of the disclosure, the wireless communication module includes a first communication module and a second communication module. The first communication module may be operable with a first protocol, and the second communication module may be operable with a second protocol different from the first protocol. The displacement data may be based on a signal transmitted via the first communication module.

According to one aspect of the disclosure, the controller is further configured to communicate with the second communication module in the overboard condition. The controller may further be configured to communicate with the first communication module when the passenger and the wireless communication device are within the target distance.

According to one aspect of the disclosure, the first protocol is a short-range radio frequency hopping protocol, and the second protocol is one of a satellite-based navigation protocol and a cellular radio frequency protocol.

According to one aspect of the disclosure, the first protocol is Bluetooth Low Energy.

According to another aspect of the present disclosure, a system for controlling a watercraft includes a database storing a user profile associated with a passenger of the watercraft. The system includes a wireless communication device associated with the passenger. The wireless communication device is configured to communicate identification information of the passenger. At least one controller is in communication with the database, the watercraft, and the wireless communication device. The at least one controller is configured to receive the identification information. The at least one controller is further configured to compare the identification information to the user profile. The at least one controller is further configured to determine, based on the comparison of the identification information to the user profile, an authorization condition. The at least one controller is further configured to communicate an instruction to control the watercraft based on the authorization condition.

According to one aspect of the disclosure, the instruction is communicated to an engine control system of the watercraft to allow activation of the engine control system.

According to one aspect of the disclosure, the wireless communication device is a wearable device attached to an appendage of the passenger.

According to one aspect of the disclosure, further includes an interface disposed on the wireless communication device and configured to receive a user input. The wireless communication device may be operable to control the engine control system based on the user input.

According to one aspect of the disclosure, the watercraft includes a steering control system operably controlled via the user input.

According to one aspect of the disclosure, the at least one controller includes a first controller onboard the watercraft for controlling the watercraft and one of a remote server and a second controller included with a mobile device.

According to one aspect of the disclosure, one of the server and the second controller is configured to determine the authorization condition and communicate the authorization condition to the first controller. The first controller may be configured to communicate the instruction.

According to one aspect of the disclosure, the user profile includes ownership data corresponding to an owner of the watercraft. Determining the authorization condition may be based further on a comparison of the identification information to the ownership data.

According to another aspect of the present disclosure, a method for controlling a watercraft includes, at one or more controllers, receiving identification information communicated from a wireless communication device associated with a passenger of the watercraft. The method further includes, at the one or more controllers, accessing a database storing a user profile associated with the passenger of the watercraft. The method further includes, at the one or more controllers, comparing the identification information to the user profile. The method further includes, at the one or more controllers, determining, based on the comparison of the identification information to the user profile, an authorization condition. The method further includes, at the one or more controllers, communicating an instruction to control the watercraft based on the authorization condition.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary implementations is illustrative only. Although only a few implementations of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary implementations without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A system for controlling a watercraft, the system comprising:
a wireless communication device corresponding to a passenger of the watercraft; and
a controller in communication with the wireless communication device and the watercraft, the controller configured to:
receive range information corresponding to a target distance between the watercraft and the wireless communication device;
receive displacement data corresponding to an actual distance between the watercraft and the wireless communication device;
compare the displacement data to the range information;
determine an overboard condition based on the comparison of the displacement data to the range information; and
communicate an instruction to control the watercraft based on the overboard condition.

2. The system of claim 1, wherein the controller is in communication with an engine control system of the watercraft, and further wherein the instruction is communicated to the engine control system to deactivate an engine of the watercraft.

3. The system of claim 1, wherein the overboard condition corresponds to the passenger being spaced from the watercraft.

4. The system of claim 1, wherein the overboard condition corresponds to the wireless communication device being spaced from the watercraft.

5. The system of claim 1, wherein the wireless communication device is a wearable device attached to an appendage of the passenger.

6. The system of claim 2, further comprising:
an interface disposed on the wireless communication device and configured to receive a user input, wherein the wireless communication device is operable to control the engine control system based on the user input.

7. The system of claim 6, further wherein the watercraft includes a steering control system operably controlled via the user input.

8. The system of claim 1, wherein the wireless communication module includes a first communication module and a second communication module, the first communication module operable with a first protocol and the second communication module operable with a second protocol different from the first protocol, and wherein the displacement data is based on a signal transmitted via the first communication module.

9. The system of claim 8, wherein the controller is further configured to:
communicate with the second communication module in the overboard condition; and
communicate with the first communication module when the passenger and the wireless communication device are within the target distance.

10. The system of claim 8, wherein the first protocol is a short-range radio frequency hopping protocol and the second protocol is one of a satellite-based navigation protocol and a cellular radio frequency protocol.

11. The system of claim 10, wherein the first protocol is Bluetooth Low Energy.

12. A system for controlling a watercraft, comprising:
a database storing a user profile associated with a passenger of the watercraft;
a wireless communication device associated with the passenger, the wireless communication device configured to communicate identification information of the passenger;
at least one controller in communication with the database, the watercraft, and the wireless communication device, the at least one controller configured to:
receive the identification information;
compare the identification information to the user profile;
determine, based on the comparison of the identification information to the user profile, an authorization condition; and
communicate an instruction to control the watercraft based on the authorization condition.

13. The system of claim 12, wherein the instruction is communicated to an engine control system of the watercraft to allow activation of the engine control system.

14. The system of claim 12, wherein the wireless communication device is a wearable device attached to an appendage of the passenger.

15. The system of claim 13, further comprising:
an interface disposed on the wireless communication device and configured to receive a user input, wherein the wireless communication device is operable to control the engine control system based on the user input.

16. The system of claim 15, further wherein the watercraft includes a steering control system operably controlled via the user input.

17. The system of claim 12, wherein the at least one controller includes a first controller onboard the watercraft for controlling the watercraft and one of a remote server and a second controller included with a mobile device.

18. The system of claim 13, wherein one of the server and the second controller is configured to determine the authorization condition and communicate the authorization condition to the first controller, and further wherein the first controller is configured to communicate the instruction.

19. The system of claim 12, wherein the user profile includes ownership data corresponding to an owner of the watercraft, and wherein determining the authorization condition is based further on a comparison of the identification information to the ownership data.

20. A method for controlling a watercraft, comprising:
at one or more controllers:
receiving identification information communicated from a wireless communication device associated with a passenger of the watercraft;
accessing a database storing a user profile associated with the passenger of the watercraft;
comparing the identification information to the user profile;
determining, based on the comparison of the identification information to the user profile, an authorization condition; and
communicating an instruction to control the watercraft based on the authorization condition.
